(19) United States
(12) Patent Application Publication
(10) Pub. No.: US 2026/0351160 A1
(43) Pub. Date: Nov. 5, 2026

(54) Apparatus and Method for Processing Display Data

(71) Applicant: LG Display Co., Ltd., Seoul (KR)

(72) Inventor: Gyeong Ho Ryu, Paju-si (KR)

(21) Appl. No.: 19/662,663

(22) Filed: Apr. 29, 2026

(30) Foreign Application Priority Data
Apr. 30, 2025 (KR) 10-2025-0057469

(51) Int. Cl. G09G 3/20

(52) U.S. Cl. CPC G09G 3/2096; G09G 2360/04; G09G 2370/10

(57) ABSTRACT

An apparatus for processing display data includes a packet generator configured to generate packets of a multi-mode from display data according to a first interface format, a stream classifier configured to classify the packets of the multi-mode into a first stream packet to be displayed on a first panel and a second stream packet to be displayed on a second panel different from the first panel, a converter configured to convert the first and second stream packets into a first signal and a second signal, respectively, of a second interface format different from the first interface format, and a multiplexer configured to multiplex and output the first and second signals.

### CROSS REFERENCE TO RELATED APPLICATION

This application claims the benefit of Republic of Korea Patent Application No. 10-2025-0057469, filed on Apr. 30, 2025, which is hereby incorporated by reference as if fully set forth herein.

### BACKGROUND OF THE DISCLOSURE

### Field of the Disclosure

The present disclosure relates to an apparatus and method for processing display data.

### Discussion of the Related Art

A liquid crystal display (LCD) using a liquid crystal, an organic light emitting diode (OLED) display using organic light emitting diodes, and an electrophoretic display (EPD) using electrophoretic particles have widely been used as display devices.

A display device includes a panel that displays an image through a pixel array, a panel driving unit that drives the panel, and a timing controller that controls the panel driving unit. The panel driving unit includes a gate driving circuit that drives gate lines of the panel and a data driving circuit that drives data lines of the panel.

In general, a timing controller is provided for each panel of the display device, and the timing controller is mounted on a board separate from the panel and coupled to the panel. In a device in which two or more panels are mounted, when one source (or host system) provides display data to the two or more panels, providing a timing controller for each panel is not advantageous in terms of space or cost.

### SUMMARY OF THE DISCLOSURE

Accordingly, the present disclosure is directed to an apparatus and method for processing display data that substantially obviate one or more problems due to limitations and disadvantages of the related art.

The present disclosure takes into account such circumstances, and an aspect of the present disclosure is to drive two panels using one timing controller.

Another aspect of the present disclosure is to provide an apparatus for processing display data to be provided to a timing controller that drives two panels.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, an apparatus for processing display data includes a packet generator configured to generate packets of a multi-mode from display data according to a first interface format, a stream classifier configured to classify the packets of the multi-mode into a first stream packet to be displayed on a first panel and a second stream packet to be displayed on a second panel different from the first panel, a converter configured to convert the first and second stream packets into a first signal and a second signal, respectively, of a second interface format different from the first interface format, and a multiplexer configured to multiplex and output the first and second signals.

In another aspect of the present disclosure, a method of processing display data includes generating multi-mode packets from display data according to a first interface format, classifying the multi-mode packets into a first stream packet to be displayed on a first panel and a second stream packet to be displayed on a second panel different from the first panel, converting the first and second stream packets into first and second signals, respectively, of a second interface format different from the first interface format, and multiplexing and outputting the first and second signals.

In still another aspect of the present disclosure, a timing controller includes a selection signal generator configured to generate a selection signal using a horizontal synchronization signal and a vertical synchronization signal, and a demultiplexer configured to separate a first signal and a second signal input in a multiplexed state based on the selection signal and to provide the separated first and second signals to a first display panel and a second display panel, respectively.

In yet another aspect of the present disclosure, a display apparatus includes a first panel and a second panel, a host configured to generate multi-mode packets from display data according to a first interface format, to classify the multi-mode packets into a first stream packet to be displayed on the first panel and a second stream packet to be displayed on the second panel, to convert the first and second stream packets into first and second signals, respectively, of a second interface format different from the first interface format, and to multiplex and output the first and second signals, and a timing controller configured to separate the first and second signals input in a multiplexed state based on a selection signal generated using a horizontal synchronization signal and a vertical synchronization signal and to provide the separated first and second signals to the first and second panels, respectively.

In yet another aspect of the present disclosure, a display apparatus includes a timing controller, a first panel, and a second panel. The timing controller includes a demultiplexer and a selection signal generator. The demultiplexer is configured to receive multiplexed LVDS data that includes a first stream signal interleaved with a second stream signal. The selection signal generator is configured to generate a first timing control signal for the first stream signal, and generate a second timing control signal for the second stream signal. The first panel includes a first data driving circuit configured to receive the first stream signal and the first timing control signal via a first communication channel. The second panel includes a second data driving circuit configured to receive the second stream signal and the second timing control signal via a second communication channel.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating an electroluminescent display device;

FIG. 2 is a configuration diagram schematically illustrating a subpixel illustrated in FIG. 1;

FIG. 3 illustrates an example in which two panels are driven by two timing controllers;

FIG. 4 schematically illustrates a form in which two panels are driven by one timing controller according to an embodiment of the present disclosure;

FIG. 5 illustrates an MST packet of eDP;

FIG. 6 illustrates a configuration of a host system that generates multiplexed display data according to an embodiment of the present disclosure;

FIG. 7 illustrates a configuration of a timing controller that receives multiplexed display data and distributes the data to each panel according to an embodiment of the present disclosure;

FIG. 8 illustrates a detailed configuration of a stream classifier in the host system of FIG. 6;

FIG. 9 illustrates logic for detecting a code pattern of an MST packet;

FIG. 10 illustrates a detailed configuration of a converter in the host system of FIG. 6;

FIG. 11 illustrates a timing control signal generated by the converter of FIG. 10;

FIG. 12 illustrates a detailed configuration of a stream multiplexer in the host system of FIG. 6;

FIG. 13 illustrates a detailed configuration of a second selection signal generator in the stream multiplexer of FIG. 12;

FIG. 14 illustrates an example in which the stream multiplexer multiplexes two LVDS streams in an interleaving manner; and

FIG. 15 illustrates a detailed configuration of a third selection signal generator in the timing controller of FIG. 7.

### DETAILED DESCRIPTION OF THE DISCLOSURE

Hereinafter, preferred embodiments will be described in detail with reference to the accompanying drawings. Throughout the specification, like reference numerals denote substantially identical components. In the following description, when it is determined that a detailed description of a known function or configuration related to the present disclosure may unnecessarily obscure or interfere with the understanding of the present disclosure, the detailed description thereof will be omitted.

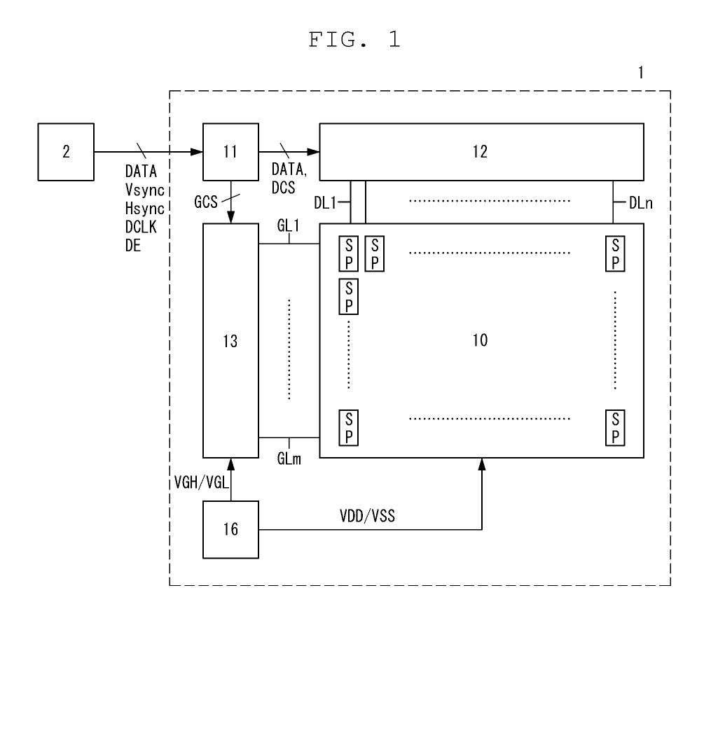

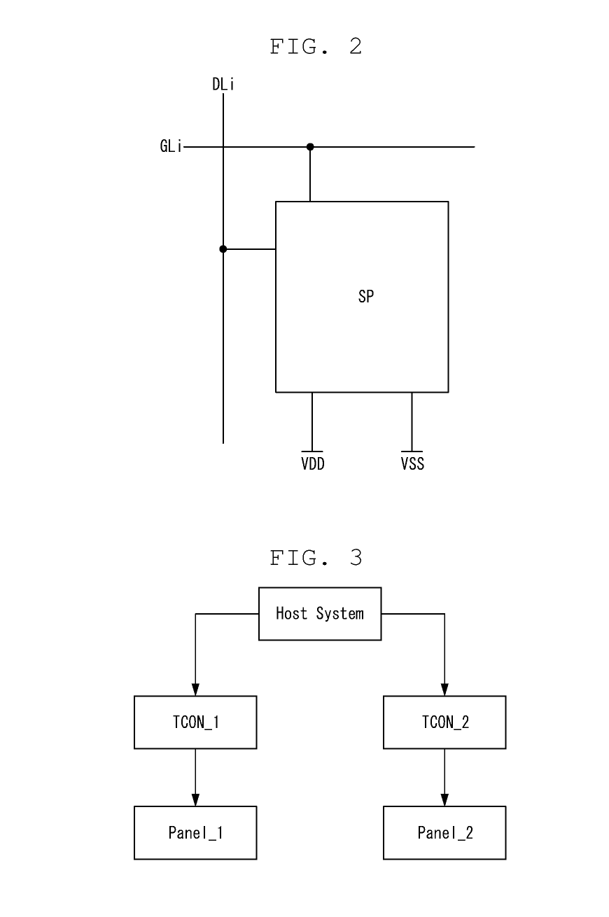

FIG. 1 is a block diagram illustrating an electroluminescent display device. FIG. 2 is a configuration diagram schematically illustrating a subpixel illustrated in FIG. 1.

Referring to FIG. 1, the electroluminescent display device 1 may include a display panel 10, a timing controller 11, a data driving circuit 12, a gate driving circuit 13, and a power circuit 16. The timing controller 11, the data driving circuit 12, and the power circuit 16 of FIG. 1 may be wholly or partially integrated within a drive integrated circuit.

On a screen of the display panel 10 on which an input image is displayed, a plurality of data lines DL extending in a column direction (or a vertical direction) and a plurality of gate lines GL extending in a row direction (or a horizontal direction) intersect with each other, and pixels are arranged in a matrix form in respective intersection regions to form a pixel array.

The display panel 10 may further include a first power line for supplying a high-level voltage VDD to the pixels and a second power line for supplying a low-level voltage VSS to the pixels. The first and second power lines are connected to the power circuit 16. The second power line may take the form of a transparent electrode covering a plurality of pixels.

Touch sensors may be disposed on the pixel array of the display panel 10. Touch input may be sensed using separate touch sensors or through the pixels. The touch sensors may be implemented as on-cell type or add-on type touch sensors disposed on the screen of the display panel, or as in-cell type touch sensors embedded in the pixel array.

In the pixel array, pixels disposed on the same horizontal line are connected to one of the data lines DL and one or more of the gate lines GL to form a pixel line. Each pixel is electrically connected to a data line DL in response to a scan signal applied through a gate line GL to receive a data voltage, and emits light by driving a light emitting element using a pixel current corresponding to the data voltage. Pixels disposed on the same pixel line simultaneously operate according to a scan signal applied from the same gate line GL.

One pixel unit may include three subpixels SP including a red subpixel, a green subpixel, and a blue subpixel, or four subpixels SP including a red subpixel, a green subpixel, a blue subpixel, and a white subpixel, but is not limited thereto. Hereinafter, a pixel refers to a subpixel.

The pixel receives the high-level voltage VDD and the low-level voltage VSS from the power circuit 16, and may include a switching transistor, a capacitor, a driving transistor, a light emitting element, etc. In addition to the light emitting element, the pixel may include a compensation circuit for compensating for degradation of the driving transistor, etc. that supplies a driving current required to drive the light emitting element. Accordingly, the subpixel SP may be simply illustrated in the form of a block as shown in FIG. 2.

The timing controller 11 supplies image data DATA transmitted from a host system 2 to the data driving circuit 12. The timing controller 11 receives timing signals such as a vertical synchronization signal Vsync, a horizontal synchronization signal Hsync, a data enable signal DE, and a dot clock DCLK from the host system 2, and generates control signals for controlling operation timing of the data driving circuit 12 and the gate driving circuit 13.

The control signals include a gate timing control signal GCS for controlling operation timing of the gate driving circuit 13 and a data timing control signal DCS for controlling operation timing of the data driving circuit 12.

Based on the data timing control signal DCS, the data driving circuit 12 samples and latches digital image data DATA input from the timing controller 11, converts the sampled and latched data into parallel data, converts the parallel data into an analog data voltage according to a gamma reference voltage through a digital-to-analog converter, and supplies the converted data voltage to the pixels through output channels and the data lines DL. The data voltage may have a value corresponding to a grayscale level to be expressed by the pixel. The data driving circuit 12 may include a plurality of integrated circuits.

The data driving circuit 12 may include a shift register, a latch, a level shifter, a DAC, and a buffer. The shift register shifts a clock input from the timing controller 11 to sequentially output clocks for sampling. The latch samples and latches digital image data at sampling clock timings sequentially input from the shift register and simultaneously outputs the sampled pixel data. The level shifter shifts a voltage of the pixel data input from the latch into an input voltage range of the DAC. The DAC converts the pixel data from the level shifter into a data voltage based on a gamma compensation voltage, and then supplies the data voltage to the data line DL through the buffer.

The gate driving circuit 13 generates a scan signal based on the gate timing control signal GCS, and generates the scan signal in a row sequential manner during an active period to sequentially apply the scan signal to the gate line GL connected to each pixel line. A specific scan signal of the gate line GL is synchronized with supply timing of a data voltage of the data line DL. The scan signal swings between a gate low voltage VGL and a gate high voltage VGH.

The gate driving circuit 13 may include a plurality of gate drive integrated circuits each including a shift register, a level shifter for converting an output signal of the shift register into a swing width suitable for driving a TFT of a pixel, and an output buffer.

Alternatively, the gate driving circuit 13 may be directly formed on a lower substrate of the display panel 10 using a GIP (Gate drive IC In Panel) method or a GIA (Gate drive IC In Active area) method. In the GIP method, the level shifter may be mounted on a printed circuit board (PCB), and the shift register may be formed on the lower substrate of the display panel 10. In the GIA method, the gate driving circuit may be distributed and disposed in an active area (in a circuit area of the pixels) of the display panel 10.

The power circuit 16 generates, using a DC-DC converter, the gate high voltage VGH and the gate low voltage VGL required for operation of the data driving circuit 12 and the gate driving circuit 13 by adjusting a DC input voltage provided from the host system 2, and generates the high-level voltage VDD and the low-level voltage VSS required for driving of the pixel array.

The host system 2 may be an application processor (AP) in a mobile device, a wearable device, a virtual/augmented reality device, or a vehicle. Alternatively, the host system 2 may be a main board of a television system, a set-top box, a navigation system, a personal computer, or a home theater system, but is not limited thereto.

Even though the display panel 10 has been described in FIGS. 1 and 2 as including an electroluminescent element, embodiments of the present disclosure may be applied to a display device using an LCD panel.

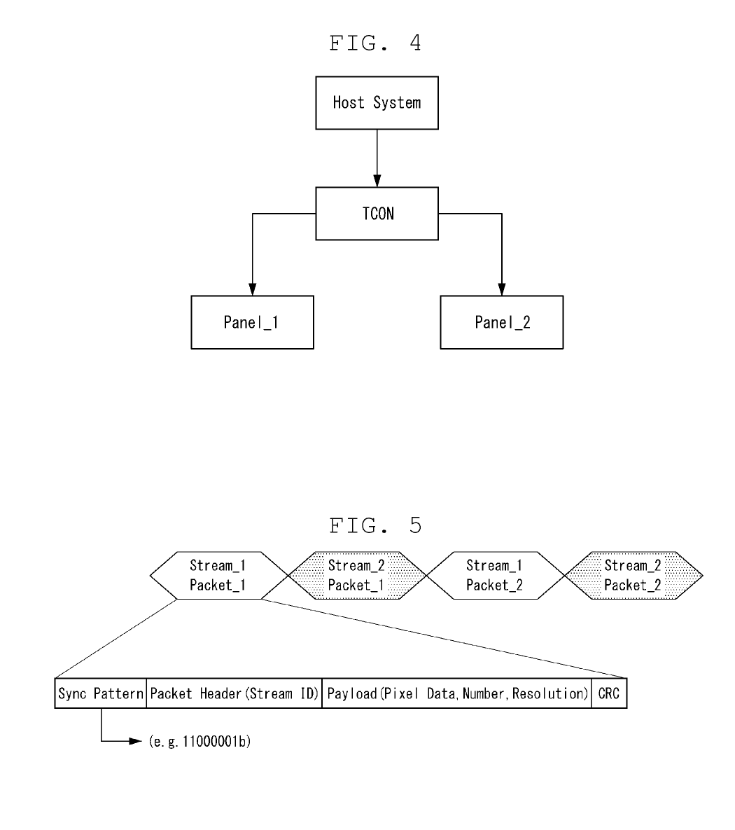

FIG. 3 illustrates an example in which two panels are driven by two timing controllers, and FIG. 4 schematically illustrates a form in which two panels are driven by one timing controller according to an embodiment of the present disclosure.

In the case of an electronic device or a vehicle including two or more display panels, as illustrated in FIG. 3, a host system generally generates display data to be displayed on each panel and provides the display data to a timing controller of each display panel. That is, it is common that one panel is driven by one timing controller.

However, since it is difficult to directly attach the timing controller to the panel, and the timing controller is mounted on a separate board and coupled to the panel, the board on which the timing controller is mounted occupies space. In addition, a separate board needs to be manufactured for each panel, resulting in additional cost and loss in a production process.

Recently, as performance of the host systems has improved and the specifications of interfaces for transmitting display data have been enhanced, the host system may transmit data of various resolutions to several timing controllers in a multi-mode.

For example, eDP (embedded Display Port) interface has a maximum communication capability of 8.1 Gbps and provides an MST (Multi-Stream Transport) mode. The MST mode may provide different display data to four HD-class display panels or up to 63 low-resolution display panels.

In addition, as the performance of the timing controller has improved, when one timing controller drives one panel, there remains a resolution margin.

In an embodiment of the present disclosure, as illustrated in FIG. 4, one timing controller may drive two panels.

To implement driving as illustrated in FIG. 4, it is necessary to design a logic circuit for the host system to generate a signal in the MST mode of the eDP interface capable of driving two panels and transmit the signal to the timing controller. In addition, it is necessary to design a logic circuit for the timing controller to distribute the signal transmitted from the host system to the two panels.

When one timing controller drives two panels as illustrated in FIG. 4, the gate driving circuit may be disposed for each panel using the GIP method or the GIA method. In one example, a first panel includes a first gate driving circuit configured to receive a first timing control signal via a first communication channel, and a second panel includes a second gate driving circuit configured to receive a second timing control signal via a second communication channel. Alternatively, when the two panels have the same vertical resolution and are arranged side by side, a single gate driving circuit may be disposed between the two panels to drive both panels. The power circuit may be provided separately for each panel, or a single power circuit may supply power to both panels.

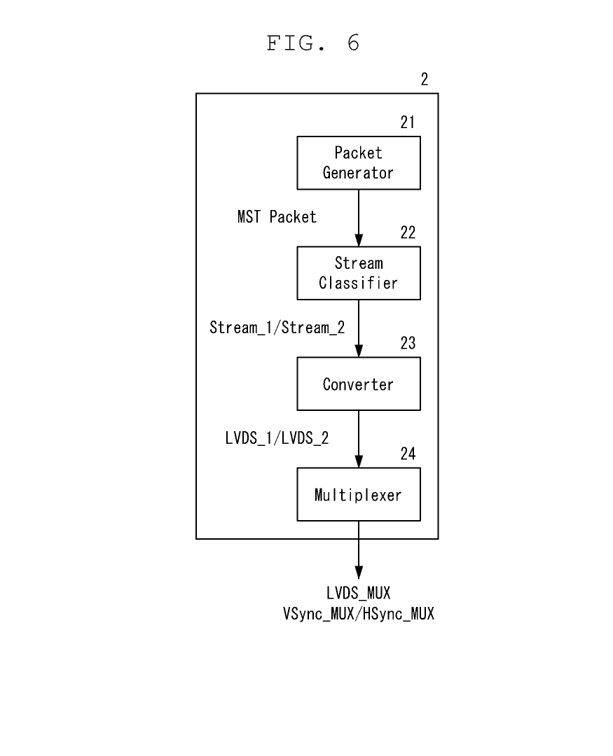

FIG. 5 illustrates an MST packet of eDP.

An MST packet generated in the MST mode of the eDP may include, as illustrated in FIG. 5, a synchronization pattern, a packet header including a stream identifier, a payload including pixel data, and a CRC (Cyclic Redundancy Check) for error detection. The MST packet may be generated on a pixel-line basis.

In the MST mode for driving two panels, a packet of a first stream Stream_1 for driving a first panel and a packet of a second stream Stream_2 for driving a second panel may be alternately generated and transmitted.

In the MST mode, each packet may be distinguished using a synchronization pattern including a predetermined number of bits, and a stream to which each packet belongs may be distinguished using the stream identifier.

The MST mode of the eDP interface for display data communication basically includes, in output data, as many streams as the number of display devices to be driven.

However, the MST mode of the eDP is not designed to provide two or more streams to a display device in which two or more panels are driven by a single timing controller. In addition, a timing controller employing the eDP interface is designed to process only one stream among data transmitted in the MST mode and is not designed to receive and process two or more streams.

Accordingly, it is necessary to distinguish MST packets by stream and convert the MST packets into another interface format that may be processed by the timing controller, so that the timing controller may process two or more streams included in data generated in the MST mode.

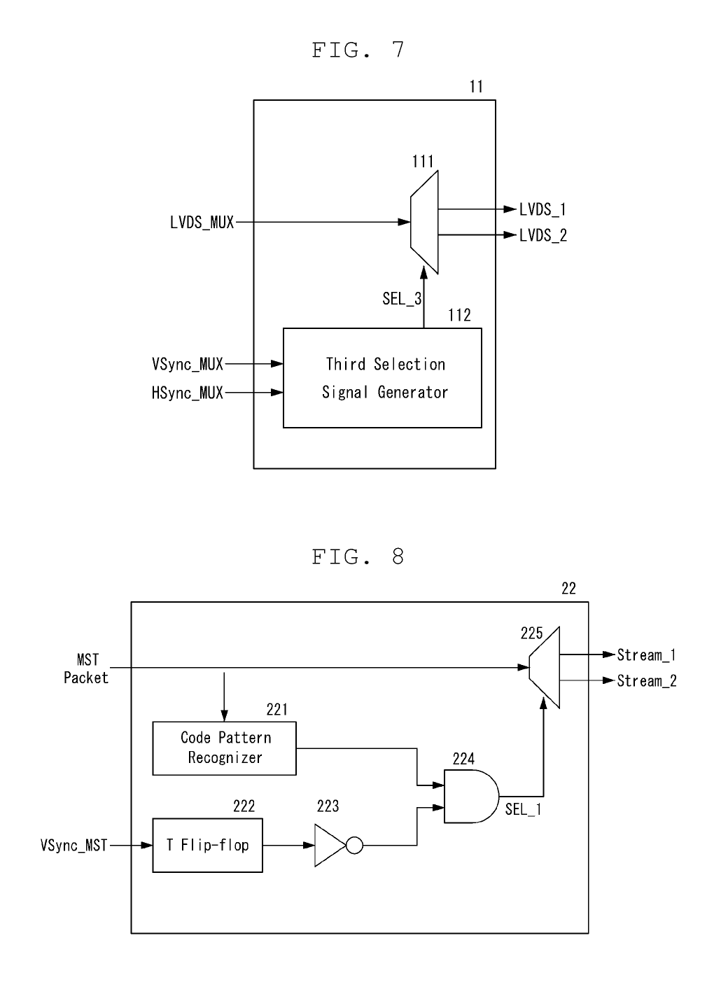

FIG. 6 illustrates a configuration of a host system that generates multiplexed display data according to an embodiment of the present disclosure, and FIG. 7 illustrates a configuration of a timing controller that receives multiplexed display data and distributes the data to each panel according to an embodiment of the present disclosure.

The host system 2 of FIG. 6 may include a packet generator 21, a stream classifier 22, a converter 23, and a multiplexer 24.

The packet generator 21 may generate, as illustrated in FIG. 5, two or more streams to be displayed on two or more panels in a packetized manner according to a multi-mode, for example, according to the MST mode of the eDP.

An MST packet generated by the packet generator 21 may include, at a leading portion, a synchronization pattern including, for example, 11000001b, and may include, in a payload, information such as a stream identifier, pixel data, a packet number, and resolution.

Since the packet generator 21 serves as a source that generates display data in a multi-mode according to an existing communication interface format, an existing packet generation module supporting the multi-mode (for example, a graphics module) may be used without change and does not have to be separately modified for the embodiment of the present disclosure.

The packet generator 21 may generate timing control signals for controlling reproduction of the MST packets, for example, a vertical synchronization signal, a horizontal synchronization signal, and a data enable signal.

When a conventional packet generation module includes the timing control signal in a packet without separately outputting the timing control signal when generating display data in the multi-mode, the packet generator 21 may further include a module for generating timing control signals including a vertical synchronization signal, a horizontal synchronization signal, etc.

The packet generator 21 may generate data for one horizontal line as one MST packet. In this case, the packet generator 21 may generate one horizontal synchronization signal in synchronization with one MST packet and may generate, for one stream, as many horizontal synchronization signals as the vertical resolution of the corresponding stream, that is, the number of horizontal lines.

When generating two streams as an MST packet, the packet generator 21 may generate, for one frame, a horizontal synchronization signal including as many pulses as the sum of the numbers of horizontal lines of the two streams, and may generate a vertical synchronization signal VSync_MST including two pulses per frame.

The two pulses included in the vertical synchronization signal VSync_MST may be generated in synchronization with the MST packet. That is, the two pulses included in the vertical synchronization signal VSync_MST may be generated in synchronization with a first packet of each frame in the first stream and a first packet of a corresponding frame in the second stream, or in synchronization with a last packet of each frame in the first stream and a last packet of a corresponding frame in the second stream.

When the first stream has a higher vertical resolution than that of the second stream, the packet generator 21 may alternately generate packets of the first stream and packets of the second stream and, after generating a packet for a last horizontal line of the second stream, may generate only packets of the first stream until a last horizontal line of the first stream.

The stream classifier 22 may classify, from packets generated in a multi-mode by the packet generator 21, for example, MST packets into two streams, and may sort and temporarily store packets corresponding to the first stream Stream_1 and packets corresponding to the second stream Stream_2.

The converter 23 may convert, for example, the first stream packet and the second stream packet generated and classified according to the eDP format into an interface format different from the eDP interface format, for example, signals in an LVDS (Low Voltage Differential Signaling) format, to generate a first LVDS signal LVDS_1 and a second LVDS signal LVDS_2.

In addition, the converter 23 may generate timing control signals for the first stream and timing control signals for the second stream, and the timing control signals may include a vertical synchronization signal VSync, a horizontal synchronization signal HSync, and a data enable signal.

The multiplexer 24 may multiplex the two LVDS signals LVDS_1 and LVDS_2 in an interleaving manner so that the two LVDS signals are alternately output (LVDS_MUX).

The multiplexer 24 may generate a multiplexed LVDS signal LVDS_MUX from the two LVDS signals LVDS_1 and LVDS_2 using the vertical synchronization signal and the horizontal synchronization signal for each stream generated by the converter 23.

In addition, the multiplexer 24 may generate and output timing control signals VSync_MUX and HSync_MUX for the multiplexed LVDS signal LVDS_MUX based on the timing control signals for the first stream and the second stream generated by the converter 23.

The timing controller 11 of FIG. 7 may receive, from the host system 2, the multiplexed LVDS signal LVDS_MUX and multiplexed timing control signals (for example, VSync_MUX and HSync_MUX), and may separate and extract LVDS signals LVDS_1 and LVDS_2 for the first stream and the second stream using the received signals.

The timing controller 11 may include a demultiplexer 111 for demultiplexing the multiplexed LVDS signal LVDS_MUX into the LVDS signals LVDS_1 and LVDS_2 for the first stream and the second stream, and a third selection signal generator 112 for generating a third selection signal SEL_3 for controlling an operation of the demultiplexer 111 based on timing control signals (for example, VSync_MUX and HSync_MUX) for the multiplexed LVDS signal.

The third selection signal generator 112 may generate a timing control signal for a first stream signal and a timing control signal for a second stream signal from the timing control signals VSync_MUX and HSync_MUX for the multiplexed LVDS signal.

The timing controller 11 may provide the demultiplexed first stream signal LVDS_1 and the timing control signal for the first stream signal to the data driving circuit of the first panel, and may provide the demultiplexed second stream signal LVDS_2 and the timing control signal for the second stream signal to the data driving circuit of the second panel. The timing controller 11 may use two distinct communication channels to provide the stream signals and corresponding timing control signals to the respective panels.

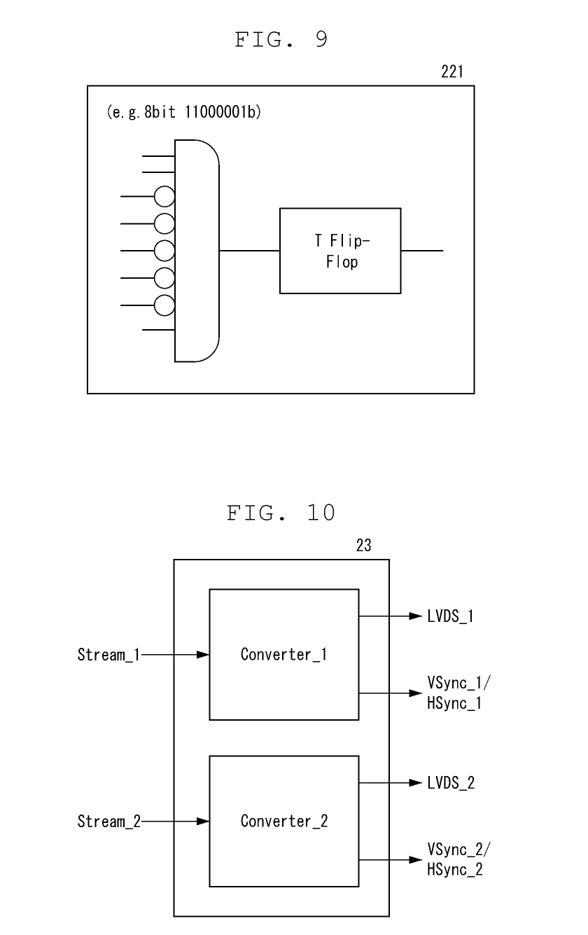

FIG. 8 illustrates a detailed configuration of the stream classifier in the host system of FIG. 6.

The stream classifier 22 may receive the MST packet and the vertical synchronization signal VSync_MST from the packet generator 21, and may separate and output a first stream packet Stream_1 and a second stream packet Stream_2.

The stream classifier 22 may include a code pattern recognizer 221, a T flip-flop 222, a NOT gate 223, an AND gate 224, and a demultiplexer 225.

The code pattern recognizer 221 for detecting the start of the MST packet may include, as illustrated in FIG. 9, an AND gate that performs an AND operation on a number of inputs corresponding to the number of bits included in the code pattern, and a T flip-flop.

Whenever 8 bits such as a code pattern included in the MST packet, for example, 11000001b are input, the code pattern recognizer 221 may alternately output 0 and 1. The T flip-flop is a logic circuit that changes a current state in response to 1 being input. For example, when the current state is 0 and 0 is input, the current state is maintained at 0, and when 1 is input, the state changes from 0 to 1. For example, when the current state is 1 and 0 is input, the current state is maintained at 1, and when 1 is input, the current state changes from 1 to 0.

For example, in the code pattern recognizer 221, for example, assuming that the state (or output) of the T flip-flop is 1, when the first MST packet is received and the code pattern 11000001b is input, 1 is input to the T flip-flop and the T flip-flop changes the output 1 to 0 and outputs 0. Thereafter, even though the bits included in the first MST packet are sequentially input, since the input bits are different from the code pattern, the AND gate having eight inputs outputs 0, and thus 0 is input to the T flip-flop, so that the T flip-flop continues to output 0.

When the second MST packet is received, 1 is input to the T flip-flop by the code pattern 11000001b, and the T flip-flop changes the output 0 to 1 and outputs 1. Even when bits included in the second MST packet are sequentially input, the T flip-flop continues to output 1.

When the third MST packet is received thereafter, the T flip-flop changes 1 to 0 and outputs 0. In this manner, the code pattern recognizer 221 may output 0 for odd-numbered MST packets and 1 for even-numbered MST packets. Alternatively, the code pattern recognizer 221 may output 1 for odd-numbered MST packets and 0 for even-numbered MST packets.

The output of the code pattern recognizer 221 may be input to the AND gate 224.

The vertical synchronization signal VSync_MST output from the packet generator 21 may be input to the AND gate 224 through the T flip-flop 222 and the NOT gate 223. Here, the vertical synchronization signal VSync_MST may be a signal generated based on timing information carried in an MST packet when the packet generator 21 generates the MST packet.

In the stream classifier 22, in the vertical synchronization signal VSync_MST including two pulses in one frame, the NOT gate 223 may output a value of 1 after a frame starts in response to input of a vertical synchronization signal of a stream having a high vertical resolution (for example, the first stream) until a first pulse corresponding to a vertical synchronization signal of a stream having a low vertical resolution (for example, the second stream) is input, and the NOT gate 223 may output a value of 0 until a second pulse corresponding to a vertical synchronization signal of the stream having a high vertical resolution (for example, the first stream) is input after the first pulse.

When a second pulse corresponding to a vertical synchronization signal of a stream having a high vertical resolution (for example, the first stream) is input, that is, when a new frame starts, the NOT gate 223 may output a value of 1 again.

When the NOT gate 223 outputs a value of 1 (during a period in which, after the start of the frame, a packet for a horizontal line of the second stream having a low vertical resolution and a packet for a horizontal line of the first stream having a high vertical resolution are alternately generated), the output value of the AND gate 224 is determined by output of the code pattern recognizer 221.

Accordingly, when the NOT gate 223 outputs a value of 1, whenever the MST packet of the first stream and the MST packet of the second stream including a code pattern at a head portion are alternately input, the code pattern recognizer 221 alternately outputs 0 and 1, and the AND gate 224 may alternately output 0 and 1 as a first selection signal SEL_1 according to the output of the code pattern recognizer 221.

When the NOT gate 223 outputs a value of 0 (from after a packet corresponding to a last horizontal line of the second stream having a low vertical resolution is generated until a packet corresponding to a last horizontal line of the first stream having a high vertical resolution is generated), the AND gate 224 may output the first selection signal SEL_1 that allows selection of the packet of the first stream regardless of the output of the code pattern recognizer 221.

The demultiplexer 225 may separate and output the packet of the first stream and the packet of the second stream according to the first selection signal SEL_1. The demultiplexer 225 may alternately output the packet of the first stream and the packet of the second stream through a first output terminal and a second output terminal according to the first selection signal SEL_1 in which 0 and 1 alternate until a first pulse corresponding to the vertical synchronization signal of the second stream having a low vertical resolution is input after a frame starts. After the first pulse, the demultiplexer 225 may continuously output the packet of the first stream through the first output terminal according to the first selection signal SEL_1 in which, for example, 0 is continuously output until a second pulse corresponding to the vertical synchronization signal of the first stream having a high vertical resolution is input.

A buffer (not illustrated) may be provided after the first output terminal and after the second output terminal of the demultiplexer 225 to temporarily store the packet of the first stream and the packet of the second stream.

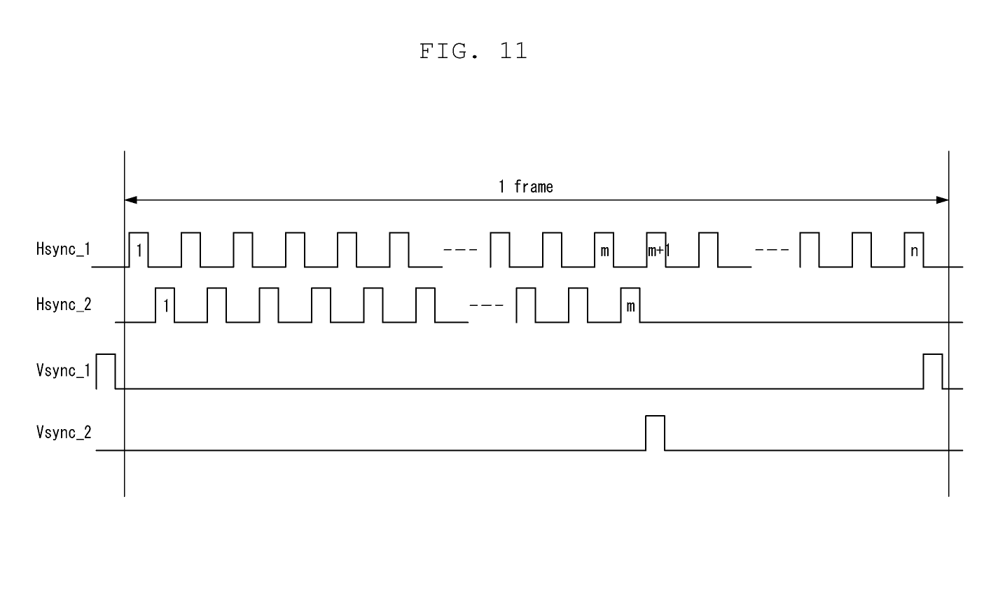

FIG. 10 illustrates a detailed configuration of the converter in the host system of FIG. 6.

The converter 23 may include two converters Converter_1 and Converter_2 configured to transform a packet according to a first communication interface into a packet signal according to a second communication interface. Here, the first communication interface may be eDP that supports a multi-mode, and the second communication interface may be LVDS.

The first converter Converter_1 of the converter 23 may transform a packet in eDP format of the first stream Stream_1 to generate a first signal LVDS_1 in LVDS format and timing control signals VSync_1/HSync_1 for the first signal, and the second converter Converter_2 may transform a packet in eDP format of the second stream Stream_2 to generate a second signal LVDS_2 in LVDS format and timing control signals VSync_2/HSync_2 for the second signal.

Since the first converter Converter_1 and the second converter Converter_2 of the converter 23 transform packets in the eDP format generated on a horizontal line basis, the first signal LVDS_1 and the second signal LVDS_2 may be generated on a horizontal line basis.

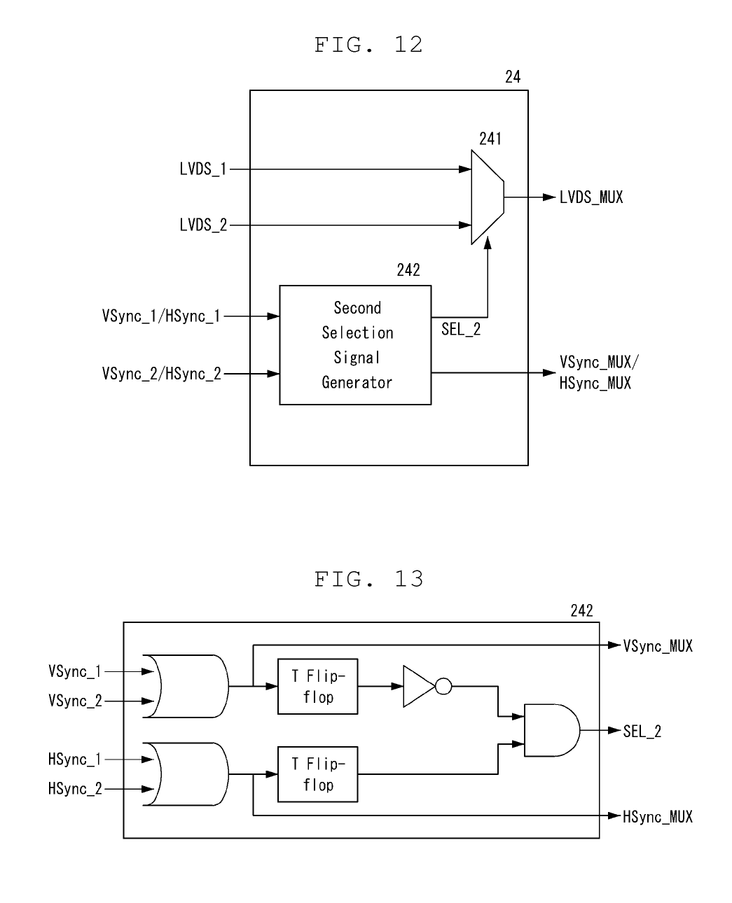

The converter that transforms the packet of the stream having a low vertical resolution may modify the timing of the timing control signal in accordance with the stream having a high vertical resolution, as illustrated in FIG. 11, in consideration of the multiplexing operation of the multiplexer 24 and the demultiplexing operation of the demultiplexer 111 of the timing controller 11.

Even though the vertical synchronization signal and the horizontal synchronization signal for the two signals LVDS_1 and LVDS_2 are used for multiplexing and demultiplexing by the multiplexer 24 and the demultiplexer 111, since vertical resolutions are different (since the numbers of horizontal lines are different), intervals of pulses included in the horizontal synchronization signal during one frame may be different.

For example, when the first stream Stream_1 has a higher vertical resolution than that of the second stream Stream_2 (that is, when the number of horizontal lines of the first stream is n and the number of horizontal lines of the second stream is m, where n > m), a horizontal synchronization signal HSync_2 for the second signal LVDS_2 generated by the second converter Converter_2 may have a wider interval between two adjacent pulses than that of a horizontal synchronization signal HSync_1 for the first signal LVDS_1 generated by a first converter Converter_1.

Accordingly, logic processing of the two horizontal synchronization signals for the first and second signals may be difficult.

Meanwhile, since a vertical synchronization signal is generated for each frame, timings of two vertical synchronization signals for the first and second signals coincide with each other, and thus logic processing of the two vertical synchronization signals may be difficult.

In consideration of the above, for example, as illustrated in FIG. 11, the second converter Converter_2 that converts the second stream Stream_2 having a low vertical resolution may generate the horizontal synchronization signal HSync_2 for the second signal LVDS_2 in synchronization with the horizontal synchronization signal HSync_1 for the first signal LVDS_1 generated by the first converter Converter_1, (with pulses included in the two horizontal synchronization signals synchronized without overlapping each other), and may generate the vertical synchronization signal VSync_2 for the second signal LVDS_2 in synchronization with a last pulse of the horizontal synchronization signal HSync_2 for the second signal LVDS_2.

FIG. 12 illustrates a detailed configuration of a stream multiplexer in the host system of FIG. 6.

The multiplexer 24 may receive the first and second signals LVDS_1 and LVDS_2 of the first and second streams and the timing control signals VSync_1/HSync_1 and VSync_2/HSync_2 from the converter 23, and may output the multiplexed signal LVDS_MUX obtained by multiplexing the first and second streams and timing control signals VSync_MUX/HSync_MUX of the multiplexed signal.

The multiplexer 24 may include a multiplexing unit 241 and a second selection signal generator 242.

The multiplexing unit 241 may output one of the first signal LVDS_1 and the second signal LVDS_2 under control of a second selection signal SEL_2 output from the second selection signal generator 242.

The second selection signal generator 242 may generate the second selection signal SEL_2 for controlling multiplexing of the first and second signals LVDS_1 and LVDS_2 based on timing control signals VSync_1/HSync_1 and VSync_2/HSync_2 for the first and second signals LVDS_1 and LVDS_2 in LVDS format, and may multiplex the timing control signals VSync_1/HSync_1 and VSync_2/HSync_2 to generate the multiplexed timing control signals VSync_MUX/HSync_MUX.

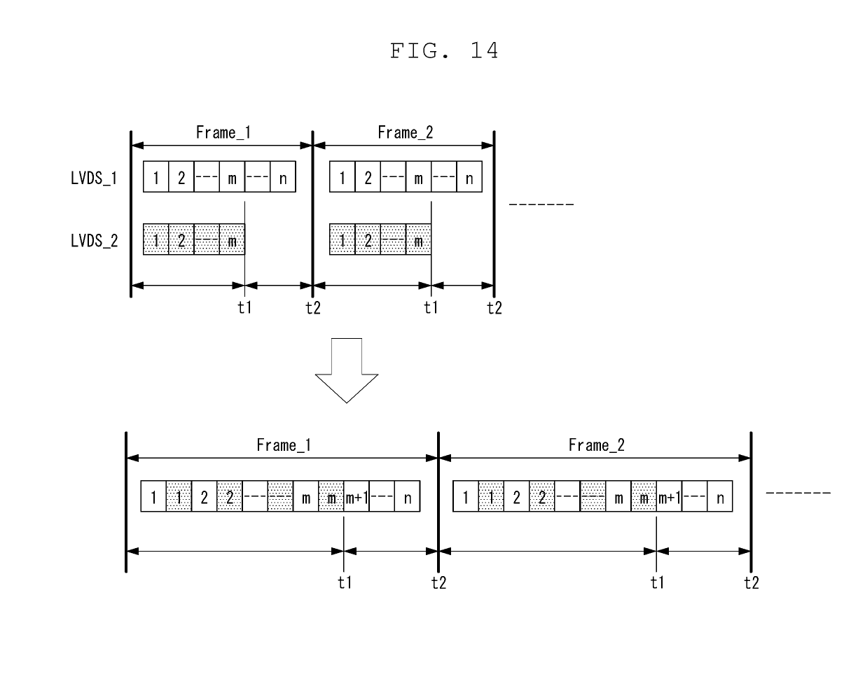

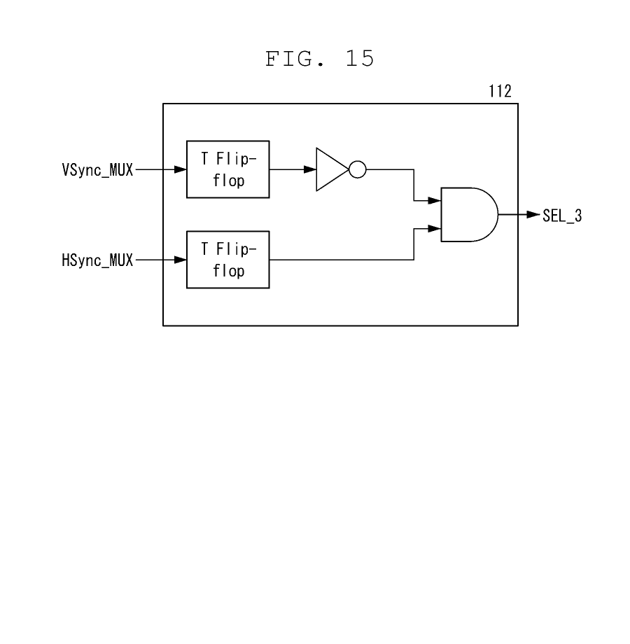

FIG. 13 illustrates a detailed configuration of the second selection signal generator in the stream multiplexer of FIGS. 12, and 14 illustrates an example in which the stream multiplexer multiplexes two LVDS streams in an interleaving manner.

The second selection signal generator 242 may include, as illustrated in FIG. 13, two OR gates, two T flip-flops, a NOT gate, and an AND gate.

The vertical synchronization signals VSync_1 and VSync_2 for the first and second signals may be OR-processed by an OR gate and converted into a multiplexed vertical synchronization signal VSync_MUX, and the horizontal synchronization signals HSync_1 and HSync_2 for the first and second signals may be OR-processed by an OR gate and converted into a multiplexed horizontal synchronization signal HSync_MUX.

The multiplexed vertical synchronization signal VSync_MUX becomes a signal having two pulses per frame, and the multiplexed horizontal synchronization signal HSync_MUX may become a signal having (n + m) pulses per frame (where n is the number of horizontal lines of the first stream, m is the number of horizontal lines of the second stream, and n > m).

The multiplexed vertical synchronization signal VSync_MUX may be input to a first input terminal of the AND gate through a T flip-flop and the NOT gate. The NOT gate may output a value of 1 from a frame start until a first time point t1 at which a first pulse of the multiplexed vertical synchronization signal VSync_MUX is input, so that the AND gate may determine a value of the second selection signal SEL_2 according to another input value. From the first time point until a second time point t2 at which a second pulse of the multiplexed vertical synchronization signal VSync_MUX is input (that is, until the end of the corresponding frame), the NOT gate may output a value of 0 so that the AND gate may output a value of 0 as the second selection signal SEL_2.

The multiplexed horizontal synchronization signal HSync_MUX may be input to a second input terminal of the AND gate through a T flip-flop.

From the frame start to the first time point t1, the multiplexed horizontal synchronization signal HSync_MUX includes 2m pulses, and 0 and 1 are each input m times to the second input terminal of the AND gate, so that the AND gate having the first input terminal to which a value of 1 is input may output the second selection signal SEL_2 having the same value as that of the second input terminal.

Accordingly, from the frame start to the first time point t1, the multiplexing unit 241 may alternately output the first signal LVDS_1 and the second signal LVDS_2 according to the second selection signal SEL_2 that alternately outputs 0 and 1.

From the first time point t1 to the second time point (frame end) t2, the multiplexed horizontal synchronization signal HSync_MUX includes (n−m) pulses. However, since a value of 0 is input to the first input terminal of the AND gate, the AND gate may output a value of 0 as the second selection signal SEL_2 regardless of the multiplexed horizontal synchronization signal HSync_MUX.

Accordingly, from the first time point t1 to the second time point t2, the multiplexing unit 241 may continuously output, for example, the first signal LVDS_1 according to the second selection signal SEL_2 that outputs a value of 0.

That is, as illustrated in FIG. 14, the multiplexing unit 241 may alternately output the first signal LVDS_1 and the second signal LVDS_2 from the frame start until the first time point t1 at which a first pulse of the multiplexed vertical synchronization signal VSync_MUX is input, and may output the first signal LVDS_1 from the first time point t1 until the second time point (frame end) t2 at which a second pulse of the multiplexed vertical synchronization signal VSync_MUX is input.

Since the first signal LVDS_1 and the second signal LVDS_2 are alternately output during a predetermined period, the output of the multiplexing unit 241 may be referred to as a multiplexed signal LVDS_MUX.

FIG. 15 illustrates a detailed configuration of a third selection signal generator in the timing controller of FIG. 7.

The timing controller 11 may, by using the multiplexed timing control signals VSync_MUX and HSync_MUX transmitted from the host system 2, separate the LVDS signal LVDS_MUX, which is multiplexed and transmitted in an interleaving manner, into an LVDS signal LVDS_1 for a first stream and an LVDS signal LVDS_2 for a second stream through the demultiplexer 111, and may provide the separated LVDS signal LVDS_1 for the first stream and the LVDS signal LVDS_2 for the second stream to a first panel and a second panel, respectively.

The third selection signal generator 112 of FIG. 15 may generate a third selection signal SEL_3, which controls the output of the demultiplexer 111 of FIG. 7, based on the multiplexed vertical synchronization signal VSync_MUX and the multiplexed horizontal synchronization signal HSync_MUX.

The third selection signal generator 112 may include a T flip-flop and a NOT gate that process the multiplexed vertical synchronization signal VSync_MUX, a T flip-flop that processes the multiplexed horizontal synchronization signal HSync_MUX, and an AND gate.

Accordingly, the third selection signal generator 112 of FIG. 15 is identical to the second selection signal generator of FIG. 13 except that the OR gates are omitted.

As described with reference to FIGS. 13 and 14, from the frame start to the first time point t1 at which the first pulse of the multiplexed vertical synchronization signal VSync_MUX is input, the multiplexed vertical synchronization signal VSync_MUX is input to the AND gate as a value of 1 through the T flip-flop and the NOT gate, and the multiplexed horizontal synchronization signal HSync_MUX is alternately input to the AND gate as values of 0 and 1 through the T flip-flop. Accordingly, the third selection signal generator 112 alternately outputs 0 and 1 as the value of the third selection signal SEL_3, and the demultiplexer 111 may separate and output the first signal LVDS_1 and the second signal LVDS_2 from the input multiplexed signal LVDS_MUX to the first output terminal and the second output terminal, respectively.

In addition, from the first time point t1 to the second time point (frame end) t2, since the multiplexed vertical synchronization signal VSync_MUX is input to the AND gate as a value of 0 through the T flip-flop and the NOT gate, the third selection signal generator 112 continuously outputs 0 as the value of the third selection signal SEL_3 regardless of the multiplexed horizontal synchronization signal HSync_MUX, and the demultiplexer 111 may output, from the multiplexed signal LVDS_MUX, the first signal LVDS_1 having a higher vertical resolution to the first output terminal.

The third selection signal generator 112 may be configured to cause the timing controller 11 to alternately output the first signal LVDS_1 and the second signal LVDS_2 in response to the timing controller 11 receiving a first value of the vertical synchronization signal (e.g., a value of 1), the first value indicating that the first signal LVDS_1 and the second signal LVDS_2 are input in the multiplexed state (e.g., LVDS_MUX). The third selection signal generator 112 may be further configured to cause the timing controller 11 to output one of the first signal LVDS_1 or the second signal LVDS_2 in response to the timing controller receiving a second value of the vertical synchronization signal (e.g., a value of 0), the second value indicating that either one of the first signal LVDS_1 or the second signal LVDS_2 is input to the timing controller 11 (e.g., the first signal LVDS_1 is input to the timing controller 11 but not the second signal LVDS_2).

The timing controller 11 may transmit the first signal LVDS_1, which is the output of the first output terminal of the demultiplexer 111, to the data driving circuit of the first panel, and may transmit the second signal LVDS_2, which is the output of the second output terminal of the demultiplexer 111, to the data driving circuit of the second panel.

In addition, the timing controller 11 may generate a vertical synchronization signal and a horizontal synchronization signal for the first signal LVDS_1 and a vertical synchronization signal and a horizontal synchronization signal for the second signal LVDS_2 from the multiplexed vertical synchronization signal VSync_MUX and the multiplexed horizontal synchronization signal HSync_MUX, and may provide the signals to the data driving circuits of the first panel and the second panel, respectively. For example, the third selection signal generator 112 may demultiplex the multiplexed timing control signals VSync_MUX/HSync_MUX to generate Vsync_1/HSync_1 for the first signal LVDS_1 and VSync_2/HSync_2 for the second signal LVDS_2.

The third selection signal generator 112 may be configured to cause the timing controller 11 to output a first horizontal synchronization signal for the first signal LVDS_1 and a second horizontal synchronization signal for the second signal LVDS_2, wherein the first and second horizontal synchronization signals are demultiplexed from the multiplexed horizontal synchronization signal HSync_MUX. The third selection signal generator 112 may be configured to further cause the timing controller 11 to output a first vertical synchronization signal for the first signal LVDS_1 and a second vertical synchronization signal for the second signal LVDS_2, wherein the first and second vertical synchronization signals are demultiplexed from the multiplexed vertical synchronization signal VSync_MUX.

When generating the horizontal synchronization signal for the second signal LVDS_2 having a lower vertical resolution from the multiplexed horizontal synchronization signal HSync_MUX, the timing controller 11 may adjust a pulse interval of the horizontal synchronization signal in consideration of the number of horizontal lines of the second signal LVDS_2.

In addition, when generating the vertical synchronization signal for the second signal LVDS_2 having a low vertical resolution from the multiplexed vertical synchronization signal VSync_MUX, the timing controller 11 may generate the vertical synchronization signal in synchronization with the vertical synchronization signal for the first signal LVDS_1.

Accordingly, by simply adding configurations for multiplexing and demultiplexing to a conventional packet generator of a host system and a timing controller, a single timing controller may provide display data to two panels without changing a communication interface.

In addition, by driving two display panels using a single timing controller, cost may be reduced.

Embodiments of the present disclosure may be summarized as follows.

An apparatus for processing display data according to an embodiment may include a packet generator configured to generate packets of multi-mode from display data according to a first interface format, a stream classifier configured to classify the packets of the multi-mode into a first stream packet to be displayed on a first panel and a second stream packet to be displayed on a second panel different from the first panel, a converter configured to convert the first and second stream packets into a first signal and a second signal, respectively, of a second interface format different from the first interface format, and a multiplexer configured to multiplex and output the first and second signals.

In an embodiment, the packet generator may generate the packets on a horizontal line basis.

In an embodiment, the stream classifier may classify the packets into the first and second stream packets based on a synchronization pattern, a vertical synchronization signal, and a stream identifier of the packets.

In an embodiment, the stream classifier may include a pattern recognizer configured to recognize the synchronization pattern in the packets, a T flip-flop that inverts in response to the vertical synchronization signal, a NOT gate configured to invert an output of the T flip-flop, an AND gate configured to receive, as inputs, an output of the pattern recognizer and an output of the NOT gate, and a demultiplexer configured to classify the packets into the first and second stream packets using an output of the AND gate as a selection signal.

In an embodiment, the multiplexer may include a first T flip-flop that inverts in response to horizontal synchronization signals for the converted first and second signals, a second T flip-flop that inverts in response to vertical synchronization signals for the converted first and second signals, a NOT gate configured to invert an output of the second T flip-flop, an AND gate configured to receive, as inputs, outputs of the first T flip-flop and the NOT gate, and a multiplexing unit configured to multiplex the first and second signals in an interleaving manner using an output of the AND gate as a selection signal.

In an embodiment, the first interface format may be eDP (embedded DisplayPort), the second interface format may be LVDS (Low Voltage Differential Signaling), and the multi-mode may be a Multi-Stream Transport (MST) mode.

A method of processing display data according to another embodiment may include generating multi-mode packets from display data according to a first interface format, classifying the multi-mode packets into a first stream packet to be displayed on a first panel and a second stream packet to be displayed on a second panel different from the first panel, converting the first and second stream packets into first and second signals, respectively, of a second interface format different from the first interface format, and multiplexing and outputting the first and second signals.

A timing controller according to another embodiment may include a selection signal generator configured to generate a selection signal using a horizontal synchronization signal and a vertical synchronization signal, and a demultiplexer configured to separate a first signal and a second signal input in a multiplexed state based on the selection signal and to provide the separated first and second signals to a first display panel and a second display panel, respectively.

In an embodiment, the selection signal generator may include a first T flip-flop that inverts in response to the horizontal synchronization signal, a second T flip-flop that inverts in response to the vertical synchronization signal, a NOT gate configured to invert an output of the second T flip-flop, and an AND gate configured to receive, as inputs, outputs of the first T flip-flop and the NOT gate and to output the selection signal.

A display apparatus according to an embodiment may include a first panel and a second panel, a host configured to generate multi-mode packets from display data according to a first interface format, to classify the multi-mode packets into a first stream packet to be displayed on the first panel and a second stream packet to be displayed on the second panel, to convert the first and second stream packets into first and second signals of a second interface format different from the first interface format, and to multiplex and output the first and second signals, and a timing controller configured to separate the first and second signals input in a multiplexed state based on a selection signal generated using a horizontal synchronization signal and a vertical synchronization signal and to provide the separated first and second signals to the first and second panels, respectively.

A display apparatus according to another embodiment may include a timing controller configured to: receive multiplexed LVDS data comprising a first stream signal interleaved with a second stream signal; and generate a first timing control signal for the first stream signal, and generate a second timing control signal for the second stream signal; a first panel comprising a first data driving circuit configured to receive the first stream signal and the first timing control signal via a first communication channel; and a second panel comprising a second data driving circuit configured to receive the second stream signal and the second timing control signal via a second communication channel.

In an embodiment, the first stream signal may be a first LVDS signal and the second stream signal is a second LVDS signal.

In an embodiment, the timing controller comprises: a demultiplexer configured to receive the multiplexed LVDS data; and a selection signal generator configured to generate the first and second timing control signals

According to the embodiments disclosed in the present disclosure, by driving two display panels using a single timing controller, it is possible to omit one board on which a timing controller is mounted, so that cost and installation space may be saved.

In addition, in the embodiments disclosed in the present disclosure, by simply adding configurations for multiplexing or demultiplexing to a conventional packet generator of a host system and to a timing controller, respectively, a single timing controller may provide display data to two panels without changing a communication interface.

From the foregoing description, those skilled in the art will appreciate that various changes and modifications may be made without departing from the technical spirit of the present disclosure. Therefore, the technical scope of the present disclosure should not be limited to content described in the detailed description of the specification, but should be defined by the appended claims.

What is claimed is:

1. An apparatus for processing display data, the apparatus comprising:
a packet generator configured to generate packets of a multi-mode from display data according to a first interface format;
a stream classifier configured to classify the packets of the multi-mode into a first stream packet to be displayed on a first panel and a second stream packet to be displayed on a second panel different from the first panel;
a converter configured to convert the first and second stream packets into a first signal and a second signal, respectively, of a second interface format different from the first interface format; and
a multiplexer configured to multiplex and output the first and second signals.

2. The apparatus according to claim 1, wherein the packet generator generates the packets on a horizontal line basis.

3. The apparatus according to claim 1, wherein the stream classifier classifies the packets into the first and second stream packets based on a synchronization pattern, a vertical synchronization signal, and a stream identifier of the packets.

4. The apparatus according to claim 3, wherein the stream classifier comprises:
a pattern recognizer configured to recognize the synchronization pattern in the packets;
a T flip-flop that inverts in response to the vertical synchronization signal;
a NOT gate configured to invert an output of the T flip-flop;
an AND gate configured to receive, as inputs, an output of the pattern recognizer and an output of the NOT gate; and
a demultiplexer configured to classify the packets into the first and second stream packets using an output of the AND gate as a selection signal.

5. The apparatus according to claim 1, wherein the multiplexer comprises:
a first T flip-flop that inverts in response to horizontal synchronization signals for the converted first and second signals;
a second T flip-flop that inverts in response to vertical synchronization signals for the converted first and second signals;
a NOT gate configured to invert an output of the second T flip-flop;
an AND gate configured to receive, as inputs, outputs of the first T flip-flop and the NOT gate; and
a multiplexing unit configured to multiplex the first and second signals in an interleaving manner using an output of the AND gate as a selection signal.

6. The apparatus according to claim 1, wherein the first interface format is eDP (embedded DisplayPort), the second interface format is LVDS (Low Voltage Differential Signaling), and the multi-mode is a Multi-Stream Transport (MST) mode.

7. A timing controller of a display apparatus, the timing controller comprising:
a selection signal generator configured to generate a selection signal using a horizontal synchronization signal and a vertical synchronization signal; and
a demultiplexer configured to separate a first signal and a second signal input in a multiplexed state based on the selection signal and to provide the separated first and second signals to a first display panel and a second display panel, respectively.

8. The timing controller according to claim 7, wherein the selection signal generator comprises:
a first T flip-flop that inverts in response to the horizontal synchronization signal;
a second T flip-flop that inverts in response to the vertical synchronization signal;
a NOT gate configured to invert an output of the second T flip-flop; and
an AND gate configured to receive, as inputs, outputs of the first T flip-flop and the NOT gate and to output the selection signal.

9. The timing controller according to claim 7, wherein the timing controller is configured to:
alternately output the first signal and the second signal in response to the timing controller receiving a first value of the vertical synchronization signal, the first value indicating that the first signal and the second signal are input in the multiplexed state, and
output one of the first signal or the second signal in response to the timing controller receiving a second value of the vertical synchronization signal, the second value indicating that only one of the first signal or the second signal is input to the timing controller.

10. The timing controller according to claim 9, wherein the timing controller is configured to:
output a first horizontal synchronization signal for the first signal and a second horizontal synchronization signal for the second signal, wherein the first and second horizontal synchronization signals are demultiplexed from the horizontal synchronization signal; and
output a first vertical synchronization signal for the first signal and a second vertical synchronization signal for the second signal, wherein the first and second vertical synchronization signals are demultiplexed from the vertical synchronization signal.

11. A display apparatus comprising:
a timing controller configured to:
receive multiplexed LVDS data comprising a first stream signal interleaved with a second stream signal; and
generate a first timing control signal for the first stream signal, and generate a second timing control signal for the second stream signal;
a first panel comprising a first data driving circuit configured to receive the first stream signal and the first timing control signal via a first communication channel; and
a second panel comprising a second data driving circuit configured to receive the second stream signal and the second timing control signal via a second communication channel.

12. The display apparatus of claim 11, wherein the first stream signal is a first LVDS signal and the second stream signal is a second LVDS signal.

13. The display apparatus of claim 11, wherein the timing controller comprises:
a demultiplexer configured to receive the multiplexed LVDS data; and
a selection signal generator configured to generate the first and second timing control signals.
